(19) United States
(12) Patent Application Publication
(10) Pub. No.: US 2026/0220388 A1
(43) Pub. Date: Jul. 30, 2026

(54) GENERATING AND EVALUATING SUMMARIES VIA RECURSIVELY AND AUTOMATICALLY TUNED MACHINE LEARNING MODELS

(71) Applicant: PAYPAL, INC., San Jose, CA (US)

(72) Inventors: Zhe Chen, Singapore (SG); Juan Xu, Shanghai (CN); Xin Kang, Shanghai (CN); Rao Fu, Shanghai (CN)

(21) Appl. No.: 19/076,597

(22) Filed: Mar. 11, 2025

(30) Foreign Application Priority Data
Jan. 27, 2025 (WO) PCT/CN2025/075475

(51) Int. Cl. G06F 40/40; G06F 16/242; G06F 40/166

(52) U.S. Cl. CPC G06F 40/40; G06F 16/243; G06F 40/166

(57) ABSTRACT

A plurality of summaries is generated by a summary generator module. A plurality of negative samples is generated by a disruptor module. Each of the plurality of negative samples is tailored to one or more specified criteria. The plurality of summaries and the plurality of negative samples are combined into a dataset. The dataset is evaluated via a summary evaluator module. Based on the evaluating, a plurality of scores is calculated for the plurality of summaries and the plurality of negative samples. Via a recursive auto prompt tuning module, at least one of the summary generator module or the summary evaluator is tuned. The tuning is automatically performed based on the calculated scores. At least the evaluating, the calculating, and the tuning are performed for one or more cycles.

### CROSS-REFERENCE TO RELATED APPLICATIONS

This application claims priority to and the benefit of International Patent Application No. PCT/CN2025/075475, filed Jan. 27, 2025, the contents of which are hereby incorporated by reference herein in its entirety.

### BACKGROUND

### Field of the Invention

The present application generally relates to machine learning. More particularly, the present application involves improving machine learning models by implementing various computer modules to automatically and recursively tune the prompts of the machine learning models.

### Related Art

Over the past several decades, rapid advances in integrated circuit fabrication and wired/wireless telecommunications technologies have brought about the arrival of the information age, in which electronic communications or interactions between various entities are becoming increasingly more common. More recently, machine learning has been developed to make predictions or generate results at a significantly faster rate and/or with better accuracy than human agents. Unfortunately, despite the advances in the field of machine learning, existing systems and methods, which are increasingly more complex and involve more and more components, lack schemes for training various components of the machine learning models in tandem such that these components collaborate with one another, rather than compete with one another in an adversarial context, particularly in situations where the prompts to the machine learning models are written in natural language. As a result, more time are computing resources are needed to accurately train machine learning models.

As such, although existing machine learning systems and methods have been generally adequate for their intended purposes, they have not been entirely satisfactory in certain aspects.

### BRIEF DESCRIPTION OF THE FIGURES

FIG. 1 is a block diagram of an example environment in which a machine learning process can be performed according to various aspects of the present disclosure.

FIG. 2 is a block diagram of a machine learning system according to various aspects of the present disclosure.

FIG. 3 is a block diagram of a process flow for performing a machine learning prompt tuning according to various aspects of the present disclosure.

FIG. 4 is a flowchart illustrating a method of machine learning according to various aspects of the present disclosure.

FIG. 5 is an example computer system according to various aspects of the present disclosure.

FIG. 6 illustrates an example system involving neural networks according to various aspects of the present disclosure.

FIG. 7 is a simplified example of a cloud-based computing architecture according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using a three-pronged approach to continuously and recursively improve machine learning. In that regard, machine learning models can be used to perform summary generation tasks, such as generating specific types of reports based on specified inputs. In order to produce high quality (e.g., accurate, relevant) outputs, machine learning models may need carefully tuned prompts. However, most prompt tuning methods rely heavily on manual adjustments (e.g., performed by human agents). For example, in contexts where the prompts are constructed from natural language (e.g., a language used in human speech, such as English), the prompts cannot be automatically optimized through conventional model training methods like gradient descent. In addition, it may be difficult to define and quantify what constitutes a “good” or “bad” summary, thereby making it challenging to evaluate the performance of the machine learning model accurately. Furthermore, it may be difficult to effectively train the various components of the machine learning model cohesively or in tandem, such that their goals and/or objectives are aligned.

To address the above challenges, the present disclosure implements a tri-pronged approach (also referred to as a “trinity” framework) that includes a summary generator module, a summary evaluator module, and a recursive auto prompt tuning module that work in conjunction with one another to help continuously improve the quality of the machine learning output. For example, the summary generator module is configured to generate summaries based on a set of prompts. These summaries are mixed in with negative samples that are purposefully generated by a disruptor module, where the negative samples correspond to lower quality and/or intentionally flawed summaries. Based on another set of prompts, the summary evaluator module is configured to evaluate the summaries (including the negative samples) and score them individually based on their perceived quality. The scores are then used by the recursive auto prompt tuning module to automatically and recursively adjust the prompts for both the summary generator module and the summary evaluator module, which may be guided by quality metrics without requiring manual intervention. In this iterative process, the various components (e.g., the summary generator module and the summary evaluator module) can evolve together, maintain alignment, and be optimized simultaneously. As a result, higher quality results can be generated by the machine learning models involved in such a scheme.

The present disclosure improves the functionality of a computer, for example, by improving the machine learning capabilities and/or the quality of the summaries generated by the machine learning models. This is achieved at least in part by using the tri-pronged framework to automatically and continuously improve the summary generator module and the summary evaluator module, for example, by iteratively adjusting their prompts based on results from the previous iterations without requiring human intervention. In addition, the various concepts of the present disclosure are particularly well suited for situations where the machine learning model prompts are written in natural language, which overcomes a particular obstacle facing conventional machine learning models: machine learning model prompts written in natural language cannot be directly tuned through traditional methods such as gradient descent. In this manner, the present disclosure is an improvement over conventional machine learning schemes.

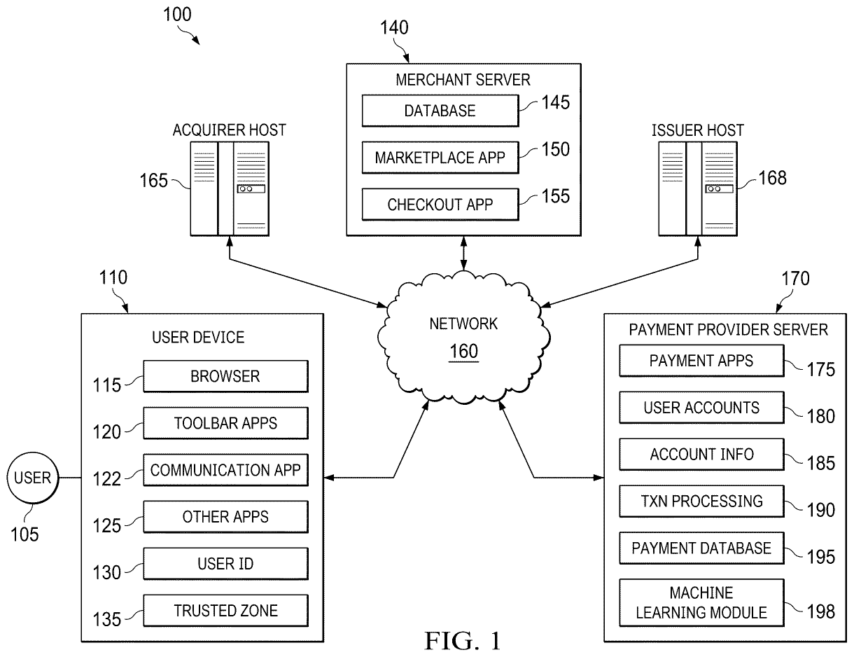

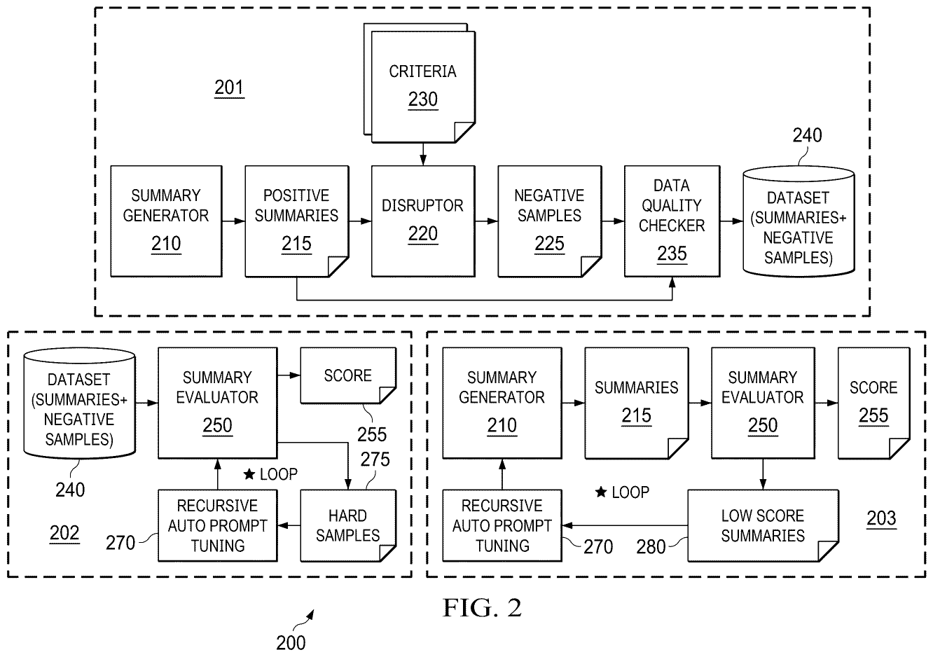

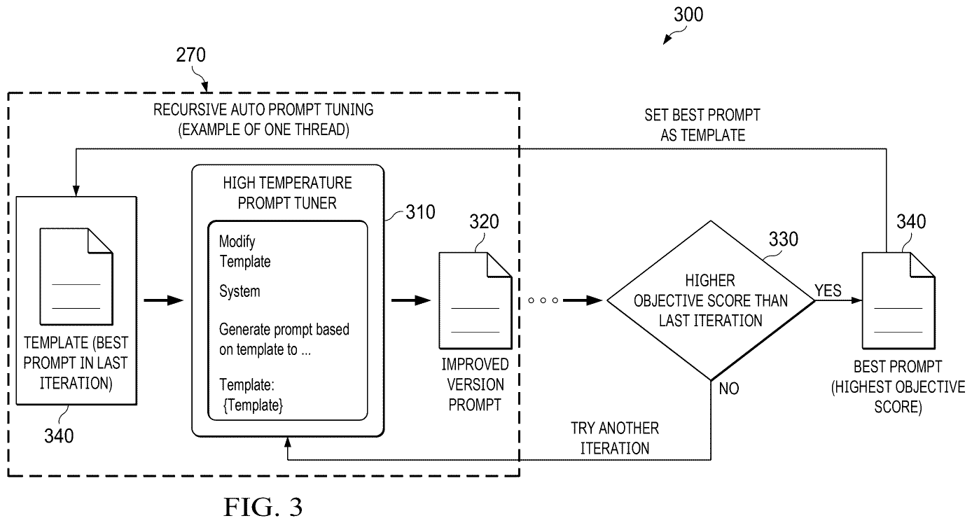

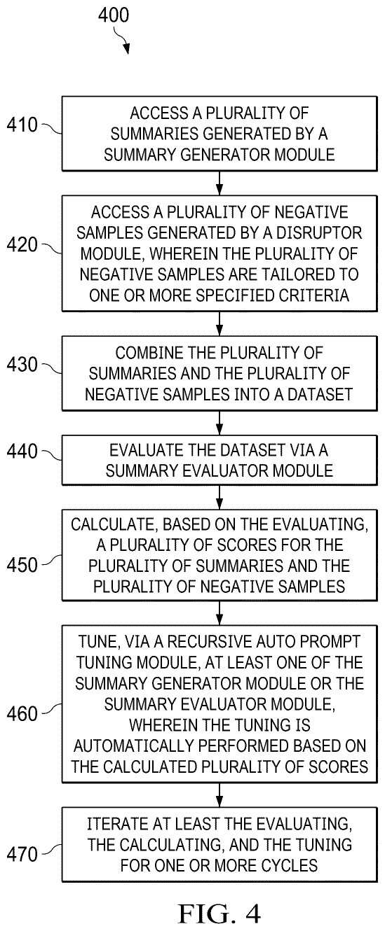

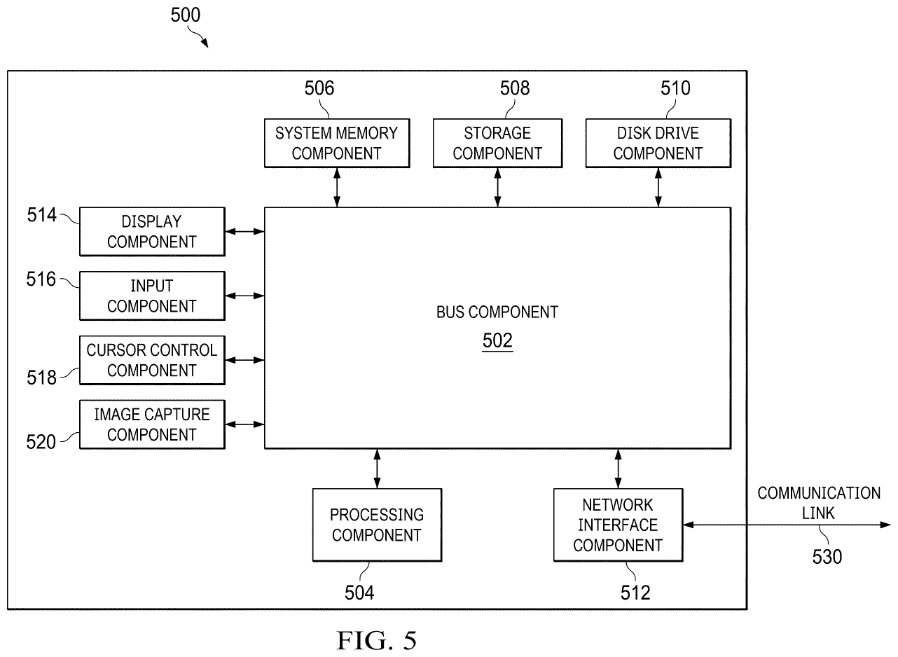

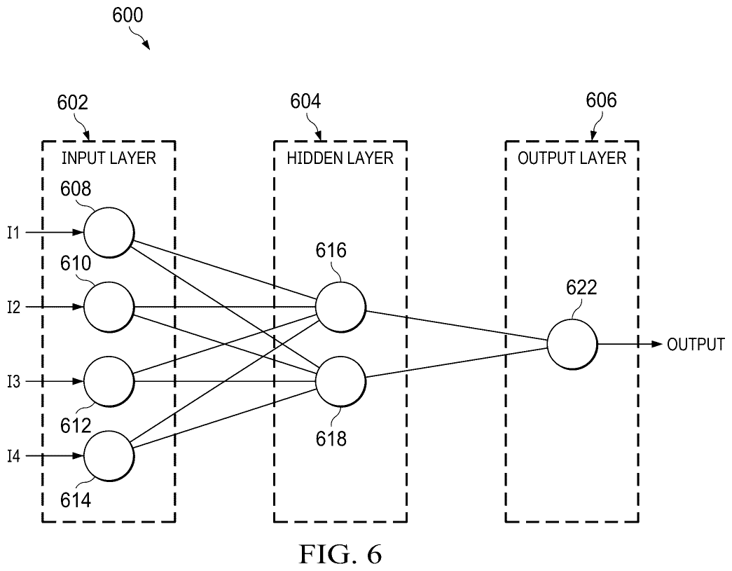

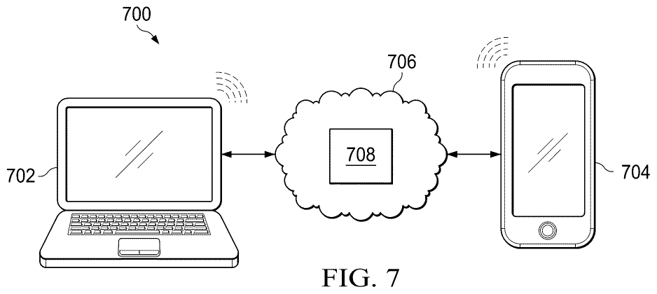

The various aspects of the present disclosure are discussed in more detail with reference to FIGS. 1-7. In more detail, FIG. 1 illustrates an example context in which a machine learning process may be generated according to embodiments of the present disclosure. FIG. 2 illustrates a block diagram of the tri-pronged framework for performing a machine learning process. FIG. 3 illustrates a process flow of tuning a prompt for a machine learning model according to embodiments of the present disclosure. FIG. 4 illustrates a flowchart of performing a machine learning process according to embodiments of the present disclosure. FIG. 5 illustrates an example computer system for performing in various methods of the present disclosure. FIG. 6 illustrates an example machine learning architecture according to embodiments of the present disclosure. FIG. 7 illustrates an example cloud computing architecture according to embodiments of the present disclosure.

Referring now to FIG. 1, a block diagram of a networked system 100 is illustrated. The networked system 100 corresponds to an environment that is suitable for conducting electronic online transactions. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, and an issuer host 168 that are in communication with one another over a network 160. Payment provider server 170 may be maintained by a payment service provider, such as PayPal™, Inc. of San Jose, CA. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, and issuer host 168 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure or trusted zone 135 owned or provisioned by the payment service provider with agreement from device manufacturer. The secure zone 135 may also be part of a telecommunications provider SIM that is used to store appropriate software by the payment service provider capable of generating secure industry standard payment credentials or other data that may warrant a more secure or separate storage, including various data as described herein.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145. In some embodiments, the merchant server 140 may also host a website for an online marketplace, where sellers and buyers may engage in purchasing transactions with each other.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a machine learning module 198 may also be implemented on, or accessible by, the payment provider server 170. The machine learning module 198 may include one or more software applications or software programs that can be automatically executed (e.g., without needing explicit instructions from a human user) to perform certain tasks. For example, the machine learning module 198 may electronically access one or more electronic databases (e.g., the database 195 of the payment provider server 170 or the database 145 of the merchant server 140) to access or retrieve electronic data pertaining to user accounts of users, such as the user 105, or transactions conducted by the user 105 or other users.

In some embodiments, the machine learning module 198 includes a trinity framework, which includes a summary generator module, a summary evaluator module, and a recursive auto prompt tuning module that work in conjunction with one another to iteratively improve the quality of summaries that can be automatically generated by machine learning module 198, as will be discussed in greater detail in FIGS. 2-3.

It is noted that although the machine learning module 198 is illustrated as being separate from the transaction processing application 190 in the embodiment shown in FIG. 1, the transaction processing application 190 may implement some, or all, of the functionalities of the machine learning module 198 in other embodiments. In other words, the machine learning module 198 may be integrated within the transaction processing application 190 in some embodiments. In addition, it is understood that the machine learning module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the machine learning module 198 may include one or more sub-modules that are configured to perform specific tasks. For example, the machine learning module 198 may include a first sub-module configured to train the machine learning model, as well as a second sub-module configured to make predictions based on the trained model.

Still referring to FIG. 1, a payment network may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. The payment network interfaces with the acquirer host 165, the issuer host 168, and/or the payment provider 170 server to facilitate transactions, according to various embodiments. For example, the payment provider server 170 may forward a transaction request to the payment network. The payment network may assess the transaction and may then send it to the acquirer host 165 or the issuer host 168 as a part of processing the transaction request. A network of communication devices, servers, and the like also may be established to relay payment related information among the different parties of a payment transaction.

Acquirer host 165 may be a server operated by a financial institution that accepts payments on behalf of merchants, such as an acquiring bank. For example, a merchant may establish an account at the acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing bank may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

Referring now to FIG. 2, a system 200 of the present disclosure is illustrated. The system 200 is configured to perform various process flows of the present disclosure. In the form of a block diagram shown in FIG. 2, the system 200 include a block 201, a block 202, and a block 203. These blocks 201-203 interact with one another as to form a tri-pronged framework in order to improve the summary generation and evaluation according to various aspects of the present disclosure. In more detail, the block 201 involves the generation of summaries. In that regard, summary generation tasks can be performed via machine learning models. As an example, the generated summary may include a suspicious activity report (SAR), which may include a plurality of suspicious transactions (e.g., conducted by uses such as the user 105 of FIG. 1) or suspicious activities such as money laundering, terrorist financing, or other types of illegal activities. The SAR may be generated by entities such as banks or other financial institutions, including but not limited to the payment provider entity that operates the payment provider server 170 discussed above with reference to FIG. 1.

According to the various aspects of the present disclosure, the block 201 of the system 200 utilizes a summary generator module 210 to generate the summaries (e.g., the SAR). The summary generator module 210 may generate the summaries in response to receiving a diverse pool of input data. For example, the input data may include user data or transaction data collected by the payment provider server 170 of FIG. 1. In some embodiments, the user data may include profile data or behavioral data of the user such as the user 105 of FIG. 1, and the transaction data may include data pertaining to a transaction amount, a transaction time, a transaction frequency, a transaction type, parties involved in the transaction, device information of devices (e.g., IP addresses, router information, browser type, etc.) used to conduct the transaction, etc. It is understood that the user data and/or the transaction data may include a plurality risk factors, internal and/or external research, product information, and other types of contextual data. The summary generator module 210 may generate one or more reports by performing electronic processing of the input data.

In some embodiments, the summary generator module 210 includes a Large Language Model (LLM), such as Large Language Model Meta Al (LLaMA) developed by META™, although it is understood that other types of LLMs may be used to implement the summary generator module 210 in other embodiments. The LLM may be trained and/or executed at least in part by feeding one or more prompts to the LLM. For example, a prompt may include a piece of text or a set of instructions as an input for the LLM to facilitate the generation of a response by the LLM. According to various aspects of the present disclosure, the prompts are recursively tuned to continuously improve the quality of the summaries generated by the summary generator module 210, for example, in terms of better consistency with the input data and/or more linguistic fluency in the structure of the summaries, as will be discussed in more detail below. In any case, as shown in FIG. 2, the summary generator module 210 may generate, as its output, a plurality of positive summaries 215, which may include the SAR discussed above in some embodiments.

The block 201 of the system 200 also includes a disruptor module 220 that is configured to generate a plurality of negative samples 225 that test and challenge an evaluator (discussed in more detail below) by simulating various quality issues. In some embodiments, the disruptor module 220 is responsible for generating synthetic negative samples from historical risk factors and corresponding summaries, such as the positive summaries 215. Based on different summary evaluation criteria (e.g., the criteria 230), the disruptor module 220 can generate distinct types of negative samples. For instance, in order to test for inconsistency as an example criterion specified by the criteria 230, the disruptor module 220 may deliberately introduce mismatches between the summaries and the input risk factors, thereby creating negative samples 225 that include summaries that are technically real but misaligned with the original data. This type of negative samples 225 may test the evaluator's ability to detect inconsistencies in the generated summaries. As another example, in order to test for a non-fluency criterion (e.g., also specified by the criteria 230), the disruptor module 220 may apply one or more types of sentence perturbations to produce negative samples 225 that include summaries that may be accurate but are written in a non-fluent manner linguistically. This helps to assess and improve the evaluator's ability to identify summaries that lack linguistic fluency. These examples discussed above are non-limiting, but they nevertheless illustrate the flexibility of the disruptor module 220 in creating negative samples tailored to specific quality criteria.

As will be discussed in more detail below, the system 200 is configured to execute a plurality of cycles of a continuous loop, where the components of the system 200 will help one another to improve upon their intended functionalities. One advantage of the disruptor module 220 in such a loop is its capacity to generate a great variety of negative samples based on historical data in each cycle of the loop, even if only “good” summaries (e.g., the positive summaries 215) are readily available initially. For example, in typical machine learning tasks, the negative sample dataset is of a fixed size. However, with the disruptor module 220, the number of negative samples 225 generated need not be limited by a fixed size. For example, to create inconsistency-based negative samples, the disruptor module 220 may mismatch input risk factors with output summaries. Since there are countless ways to create such mismatches, the resulting negative samples 225 can be generated continuously. In some embodiments, such a process may rely solely on historical data, such as past risk factors and summaries. In other words, the disruptor module 220 is a component that can dynamically generate negative samples 225 on demand, thereby eliminating the need for a fixed-size negative sample dataset.

The block 201 of the system 200 may further include a data quality checker module 235. The data quality checker module 235 is configured to check the negative samples 225 and to determine whether the negative samples are “sufficiently negative.” In other words, the data quality checker module 235 is configured to determine whether the negative samples 225 meet the intended negativity criteria specified by the criteria 230. The data quality checker module 235 also receives the output from the positive summaries 215 to help determine whether the positive summaries are “sufficiently positive” as well. In some embodiments, the data quality checker module 235 includes a Named Entity Recognition (NER) algorithm to compare the entities in the summaries with the risk factors. If the entities do not align, it indicates a reasonable negative sample summary for the negative samples 225. However, if the entities do align, it indicates a reasonable positive sample summary for the positive summaries 215. This approach can automate the process of verifying whether positive and negative sample summaries are appropriate, as well as to validate negative summaries.

Once the data quality checker module 235 deems that the negative samples 225 are sufficiently negative and/or that the positive summaries 215 are sufficiently positive, the data quality checker module 235 may then combine the positive summaries 215 and the negative samples 225 into a combined dataset 240. It is understood that the implementation of the data quality checker module 235 may be optional, and therefore it may be omitted in some embodiments. In these embodiments, the positive summaries 215 and the negative samples 225 may be combined into the combined dataset 240 without having been checked by the data quality checker module 235.

In some embodiments, the following pseudo code may be used to implement the block 201 (or portions thereof):
Function: get_synthesize_dataset
Input: Generator G, criteria C, Data quality checker DC
Use G to generate M positive examples
Use the predefined N criteria C to build a disruptor DD
Use DD to disrupt the M examples (e.g., sentence perturbation to generate non-fluency; mismatch input and summary to generate inconsistency) and generate N negative examples
Use DC to filter out low quality examples and get the synthesize dataset

Still referring to FIG. 2, in a block 202 of the system 200, the combined dataset 240 is sent to a summary evaluator module 250 for evaluation. In some embodiments, the summary evaluator module 250 also includes an LLM, which may be the same type of LLM that was used to implement the summary generator module 210 in some embodiments, or it may be a different type of LLM than that used to implement the summary generator module 210 in some other embodiments. As discussed above, the negative samples 225 in the combined dataset 240 introduce lower-quality and/or flawed summaries to be evaluated. The summary evaluator module 250 is configured to assess the quality of the summaries of the combined dataset 240, and the goal for the summary evaluator module 250 is to distinguish between the good summaries (e.g., the positive summaries generated by the summary generator module 210) and bad summaries (e.g., the negative samples generated by the disruptor module 220). For example, the summary evaluator module 250 evaluates whether each of the summaries meets one or more specified criteria, such as consistency with the input data and linguistic fluency. Thus, the summary evaluator module 250 serves as a quality control mechanism to ensure that the generated summaries align accurately with the risk factors, research, and/or product information provided, while also maintaining clarity and readability. In this manner, the summary evaluator module 250 may be used to continuously monitor the performance of the summary generation in block 201 of the system 200.

One example type of output generated by the summary evaluator module 250 is a list of scores. For example, in some embodiments, the summary evaluator module 250 operates by scoring the summaries based on a list of specified criteria to distinguish the high-quality outputs from those that may be inconsistent or non-fluent. In the embodiment shown in FIG. 2, the summary evaluator module 250 is configured to generate a plurality of scores 255 in block 202 (see both block 202 and block 203), where a respective score is generated for each summary evaluated by the summary evaluator module 250. In some embodiments, the higher the score 255 is, the better the corresponding summary is deemed to be by the summary evaluator module 250.

The scores 255 may be used to continuously improve the summary generator module 210 and/or the summary evaluator module 250. For example, the scores 255 may be used to adjust the prompts for the LLMs of the summary generator module 210 and/or the summary evaluator module 250. In that regard, the system 200 implements a recursive auto prompt tuning module 270 in blocks 202 and 203 to automatically optimize the LLM prompts, which eliminates the need for manual intervention in machine learning prompt design. This amounts to an improvement over conventional machine learning. For example, machine learning model prompts are typically tuned using methods such as gradient descent. However, gradient descent cannot be used to directly tune machine learning models prompts that are written in natural language. In the context of the present disclosure, the machine learning model prompts (e.g., for the summary generator module 210 and/or the summary evaluator module 250) are written in natural language, and therefore they cannot be directly tuned using gradient descent or various other types of conventional techniques for tuning non-natural language machine learning model prompts. Other methods for tuning natural language machine learning model prompts often rely on manually (e.g., by a human) modifying or replacing words or phrases in the prompt text, which can be time-consuming and thus suboptimal.

In contrast, the recursive auto prompt tuning module 270 herein addresses the various shortcomings discussed above by implementing an automated process that iteratively refines the machine learning model prompts toward a better performance, without the need for the manual adjustment of prompts. For example, the recursive auto prompt tuning module 270 employs an asynchronous approach to create multiple prompt tuners that generate improved versions of LLM prompts in parallel.

An example embodiment of the recursive auto prompt tuning module is illustrated in FIG. 3 with a process flow 300. The process flow 300 illustrates an example of one thread of the recursive auto prompt tuning module, but it is understood that the recursive auto prompt tuning module may have multiple threads in various embodiments. As discussed above, a plurality of different prompts may be used to get the summary generator module 210 to generate different summaries. After being evaluated by the summary evaluator module 250, each of the summaries may be assigned a respective score 255 (see FIG. 2) by the summary evaluator module 250. The prompt whose summary that yielded the best score may then be used as the template. For example, suppose 20 different prompts were used by the summary generator module 210 to generate different summaries, and also suppose that the summary corresponding to prompt #5 was scored the best by the summary evaluator module 250. The prompt #5 may then be used as the template prompt for the next iteration.

As shown in FIG. 3, the recursive auto prompt tuning module 270 may include a prompt tuner 310 to modify the template prompt. Rather than manually swapping out different words of the prompt, the prompt tuner 310 may generate a completely revised prompt based on the template prompt. This process need not rely on a specific algorithm. Instead, the revised prompt (which may be in any suitable prompt format) is crafted to guide the LLM of the summary generator module 210 or the LLM of the summary evaluator module 250 in creating these modifications with higher coherence, consistency, and/or fluency. In some embodiments, the prompt tuner 310 is a high temperature prompt tuner. In that regard, temperature is a parameter in an LLM that controls a randomness of an output generated by the LLM. A higher temperature ensures the output of LLM is more “random”, so that a more diverse output can be generated. In any case, the high temperature tuners evolve the LLM prompts by using the previous best-performing prompt as a prompt template (also interchangeably referred to as a template prompt), and then modifying the prompt template for the next iteration. The evolution is guided by the principle that each prompt version is based on the best version from a previous iteration, thereby ensuring that the prompts are gradually improved in each iteration. In the illustrated embodiment herein, the higher temperature of the prompt tuner 310 helps to ensure the randomness and diversity of the output of the LLMs of the summary generator module 210 or the summary evaluator module 250. It is understood, however, that other types of prompt tuners may be used to implement the prompt tuner 310 in other embodiments.

In any case, an improved version of the prompt 320 is generated by the prompt tuner 310 in this example. It is understood that this improved version of the prompt 320 may include a single prompt in some embodiments, or it may include multiple prompts in some other embodiments. The improved version of the prompt 320 may then be used by the summary generator module 210 to generate additional summaries. These additional summaries are then scored by the summary evaluator module 250. A determination is then made at step 330 of the process flow 300 as to whether the improved version of the prompt 320 yielded higher objective score(s) (as scored by the summary evaluator module 250) than the previous iteration. If the answer is no, then the process flow 300 may return to the step where the prompt tuner 310 may be used to modify the template prompt again. On the other hand, if the answer from the determination step 330 is yes, then a best prompt 340 that yielded the highest objective score may be used as a new template prompt as an input for the prompt tuner 310 for the next iteration. The process flow 300 may be repeated for a set number of cycles (e.g., a hundred iterations) in some embodiments. In other embodiments, the process flow 300 may be repeated until an average score of the summaries (generated by the summary generator module 210) in a current cycle is no better than an average score of the summaries of a previous cycle.

In the above example, the operations of the recursive auto prompt tuning module 270 are explained using the tuning of the summary generator module 210 as an example. However, it is understood that the summary evaluator module 250 may also be tuned by the recursive auto prompt tuning module 270 in a similar manner. For example, an average score for the positive summaries 215 and an average score for the negative samples 225 may be calculated. The optimal prompt for the summary evaluator module 250 may be configured to maximize the average score for the positive summaries 215 while minimizing it for the negative samples 225. Similar to how the summary generator module 210 is tuned, the recursive auto prompt tuning module 270 may generate a new prompt for the summary evaluator module 250 based on the existing template prompt. It is understood that the prompts for both the summary generator module 210 and the summary evaluator module 250 may be tuned in any given iteration in some embodiments. In other embodiments, however, the prompts for the summary generator module 210 may be tuned, while the prompts for the summary evaluator module 250 may be kept fixed, or vice versa.

In some embodiments, hard samples 275—those that the summary evaluator module 250 struggled with in terms of its evaluation in the prior iteration—may optionally be integrated into the prompt tuners (e.g., the prompt tuner 310) of the recursive auto prompt tuning module 270 to aid in generating a more refined prompt for the next evaluation. For example, the summary evaluator module 250 may assess the quality of the summaries produced by each prompt and may assign a score corresponding to each prompt. The prompt that generates summaries with the highest average score, and one that outperforms the previous template, is then selected as the new prompt template for the next iteration. If no better prompt is found, the process reruns with the existing template until an improvement is achieved. This recursive process allows the prompts to evolve in alignment with the objective function of optimizing summary quality and fluency.

In some embodiments, low score summaries 280 (e.g., the summaries receiving scores below a specified threshold from the summary evaluator module 250) may also be optionally used to facilitate the tuning of the LLMs of the summary generator module 210 or the LLMs of the summary evaluator module 250. For example, as discussed above, the best-performing prompt(s) may serve as the template. At the same time, the low score summaries 280 may also be provided as an additional input to the recursive auto prompt tuning module 270, and the recursive auto prompt tuning module 270 may be asked to produce new version(s) of prompt(s) from the template, while ensuring that the new version(s) of the prompt(s) should be designed to perform better than the low scoring summaries 280 from the previous cycle.

Based on the above discussions, it can be seen that by leveraging this automated, iterative tuning process of the system 200, the prompts can be configured to adapt to any given task's requirements in a dynamic and efficient manner. As such, the system 200 enables a continuous improvement of machine learning models and can be easily integrated into a desired end-to-end framework, where it is generalizable and can play a critical role in enhancing both the performances of the summary generator module 210 and the summary evaluator module 250.

In some embodiments, the following pseudo code may be used to implement the block 202 (or portions thereof):
Function: get_best_evaluator
Input: synthesize dataset D, recursive auto prompt tuning (for evaluator)PTE, max round K
while iteration time<K do
   Use the evaluator to score on D
   Get the evaluator score of current round & collect hard examples of current round
   if evaluatorscore of current round is not better than previous round
      break
   else
      Feed the examples (optionally emphasize hard examples) to PTE to get a new evaluator
   end
End

In some embodiments, the following pseudo code may be used to implement the block 203 (or portions thereof):
Function: get_best_generator
Input: evaluator E, recursive auto prompt tuning (for summary generator) PTG, max round K
while iteration time<K do
   Use the generator to generate M examples
   Use E to get score for generator on the M examples
   if generatorscore of current round is not better than previous round
      break
   else
      Feed the examples (optionally emphasize bad examples) to PTG to get a new generator
   end
end

In some embodiments, the following pseudo code may be used to tune the summary generator 210 or the summary evaluator 250 (or portions thereof):
Function: get_best_generator_and_evaluator
Input: recursive auto prompt tuning for generator PTG, recursive auto prompt tuning for evaluator PTE, criteria C, Data quality checker DC, max inner round K, max outer round M
Initial generator G, evaluator E
while iteration time<M do
   D←get_synthesize_dataset(G, C, DC)
   E←get_best_evaluator(D, PTE, K)
   G←get_best_generator(E, PTR, K)
end
Final E, G as result

FIG. 4 is a flowchart illustrating a method 400 for performing a machine learning process according to various aspects of the present disclosure. In some embodiments, the various steps of the method 400, which are described in greater detail below, may be performed by a single system. The single system may include one or more computer processors and a non-transitory computer-readable medium having stored thereon instructions that are executable by the one or more processors to cause the system to perform the steps of the method 400. In some embodiments, the system may include a computer of an entity, such as a payment provider, an operator of an electronic transaction platform, a healthcare corporation, or a business analyst, etc. In some embodiments, at least some of the steps of the method 400 may be performed by the machine learning module 198 or the system 200 discussed above.

The method 400 includes a step 410 to access a plurality of summaries generated by a summary generator module. In some embodiments, the summary generator module may be implemented as the summary generator module 210 of FIG. 2, and the plurality of summaries may include the positive summaries 215 of FIG. 2. In some embodiments, the plurality of summaries generated by the summary generator module do not have (or are not) large summaries, but rather have (or are) writeups used in the evaluation.

The method 400 includes a step 420 to access a plurality of negative samples generated by a disruptor module. The plurality of negative samples are tailored to one or more specified criteria. In some embodiments, the disruptor module may be implemented as the disruptor module 220 of FIG. 2, and the plurality of negative samples may include the negative samples 225 of FIG. 2.

The method 400 includes a step 430 to combine the plurality of summaries and the plurality of negative samples into a dataset. In some embodiments, the plurality of summaries and the plurality of negative samples are combined into a dataset 240 of FIG. 2 only when the data quality checker module 235 ensures that the quality of both the positive summaries 215 is sufficiently “good” and that the quality of the negative samples 225 is sufficiently “bad.”

The method 400 includes a step 440 to evaluate the dataset via a summary evaluator module. In some embodiments, the summary evaluator module may be implemented as the summary evaluator module 250 of FIG. 2.

The method 400 includes a step 450 to calculate, based on the evaluating of step 440, a plurality of scores for the plurality of summaries and the plurality of negative samples. In some embodiments, the calculating is performed by the summary evaluator module 250 of FIG. 2.

The method 400 includes a step 460 to tune, via a recursive auto prompt tuning module, at least one of the summary generator module or the summary evaluator module. The tuning is automatically performed based on the calculated plurality of scores. In some embodiments, the recursive auto prompt tuning module may be implemented as the recursive auto prompt tuning module 270 of FIG. 2.

The method 400 includes a step 470 to iterate one or more of the steps 410-460 for one or more cycles. For example, the steps 410-460 may be repeated for one or more cycles.

In some embodiments, the plurality of summaries comprises reports of a specified type of user activity, such as a suspicious activity. In some embodiments, the plurality of summaries is generated by the summary generator module based on a plurality of inputs to the summary generator module, where the plurality of inputs comprise: one or more risk factors, an internal research result, an external research result, or a product information.

In some embodiments, the summary generator module or the summary evaluator module comprises a large language model (LLM), and the tuning comprises tuning one or more prompts of the LLM. In some embodiments, the one or more prompts of the LLM are written in a natural language. In some embodiments, the tuning is performed at least in part by selecting a prompt of the one or more prompts that yielded a highest score as a template prompt for a subsequent cycle of the one or more cycles.

In some embodiments, the plurality of negative samples is generated by simulating a non-fluency as the one or more specified criteria. In some embodiments, the non-fluency is simulated at least in part by applying one or more sentence perturbations.

In some embodiments, the plurality of negative samples is generated by simulating an inconsistency as the one or more specified criteria. In some embodiments, the inconsistency is simulated at least in part by introducing one or more mismatches between at least some of the plurality of summaries and one or more data inputs used by the summary generator module to generate the plurality of summaries.

In some embodiments, at least the tuning and the iterating are performed automatically without human intervention.

In some embodiments, the iterating stops when an average score of the plurality of summaries of a current cycle of the one or more cycles is no better than an average score of the plurality of summaries of a previous cycle of the one or more cycles.

It is understood that additional method steps may be performed before, during, or after the steps 400-470 discussed above. For example, the method 400 may include a step to generate the positive summaries, or another step of generate the negative samples. As another example, the method 400 may include a step of feeding hard samples as an input to the recursive auto prompt tuning module to improve the quality of the summary evaluator module. As yet another example, the method 400 may include a step of feeding low score summaries as an input to the recursive auto prompt tuning module to improve the quality of the summary generator module. Other steps of the method 400 may also be performed, but they are not specifically discussed herein for reasons of simplicity.

FIG. 5 is a block diagram of a computer system 500 suitable for implementing various methods and devices described herein, for example, the machine learning module 198, the user device 110, the merchant server 140, or the payment provider server 170. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the machine learning module 198 or the system 200 and the various method steps of the method 400 discussed below (or the user device 110, the merchant server 140, or the payment provider server 170) may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the machine learning module 198 or the system 200 may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the machine learning module 198 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the machine learning module 198 (or the system 200) and external devices, for example with the user device 110, with the merchant server 140, or with the payment provider server 170, depending on exactly where the machine learning module 198 (or the system 200) is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the machine learning module 198 (or the system 200) may be implemented as such software code.

As discussed above, machine learning is used to generate and/or evaluate summaries. In some embodiments, the machine learning may be performed at least in part via an artificial neural network, which may be used to implement the machine learning module 198 of FIG. 1, the summary generator module 210 and the summary evaluator module 250 of FIG. 2, or portions thereof. In that regard, FIG. 6 illustrates an example artificial neural network 600 as one type of machine learning model. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement the machine learning module 260, and the machine learning module 260 may include as many hidden layers as necessary.

In this example, the artificial neural network 600 receives a set of input values and produces an output value. Each node in the input layer 602 may correspond to a distinct input value. For example, when the artificial neural network 600 is used to implement the machine learning modules 198 or the system 200, each node in the input layer 602 may correspond to a distinct parameter of an event.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module 260, the output value produced by the artificial neural network 600 may indicate a likelihood of an event (e.g., a probability that a particular event may occur).

The artificial neural network 600 may be trained by using training data. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the predicted classification) of an event is inconsistent with the actual classification of the event, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, gradient boosting may be used to implement the machine learning, which is a machine learning technique for regression and classification problems. Gradient boosting generates a prediction model, which could be in the form of decision trees. As another example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the machine learning module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the machine learning process as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

In summary, the machine learning model tuning process of the present disclosure integrates various components (e.g., the disruptor module 220, the summary generator module 210, and the summary evaluator module 250 of FIG. 2) into an iterative framework designed to continuously improve the quality of the generated summaries, as well as the capability of evaluating the generated summaries. In some embodiments, this process may operate solely on historical summaries provided by agents and a set of predefined criteria for generating negative samples. Through each iteration of a plurality of cycles, the system herein iteratively refines the performance of both the summary generator module 210 and the summary evaluator module 250 by using dynamically synthesized negative samples and continuously evolving prompts. For example, at the beginning of each iteration, the disruptor module 220 generates a set of negative samples (e.g., the negative samples 225 of FIG. 2) based on specific criteria (e.g., the criteria 230 of FIG. 2), such as inconsistency. Using inconsistency as a simplified example criterion, the disruptor module 220 mismatches the input risk factors with real summaries, thereby creating negative samples that are real summaries but do not align with the input risk factors. If the summary evaluator module 250 is able to detect them, then the summary evaluator module 250 may be deemed to have good capability to identify inconsistency.

Meanwhile, the summary generator module 210 takes the input risk factors and generates summaries designed to be consistent and fluent. These newly generated summaries, along with the negative samples 225 from the disruptor module 220, are then passed to the summary evaluator module 250 for evaluation. The summary evaluator module 250 analyzes each summary against its corresponding input risk factor and assigns scores based on specified criteria like consistency and fluency. As the evaluation proceeds, the recursive auto prompt tuning module 270 works in multiple parallel threads to refine the prompts for both the summary generator module 210 and the summary evaluator module 250. For example, the recursive auto prompt tuning module 270 may use the feedback from the scores generated by the summary evaluator module 250 to optimize the prompts, thereby gradually evolving them to improve the performance of both the summary generator module 210 and the summary evaluator module 250.

Through this cyclical process discussed above, each iteration enhances the overall ability of the system to generate high-quality summaries. The design of the framework of the present disclosure ensures continuous improvement by balancing the generation of both positive summaries and negative samples, thus allowing the system to learn how to better distinguish between high-quality outputs and flawed ones. This iterative, multi-component process ultimately leads to more accurate and fluent summaries over time.

The present disclosure offers advantages over existing machine learning schemes.. It is understood, however, that not all advantages are necessarily discussed in detail herein, different embodiments may offer different advantages, and that no particular advantage is required for all embodiments. For example, existing machine learning model training often relies on adversarial networks, which train a generator and a discriminator in opposition to each other. That is, the generator creates an output (e.g., images), and the discriminator distinguishes between real outputs and fake outputs (e.g., real images v.s. fake images). Thus, in adversarial training, the generator and the discriminator compete with each other to outmatch the other. However, adversarial training has drawbacks such as a high computational overhead (which leads to higher costs), increased complexity (which may also lead to higher costs), reduced generalization (since they are often overfitted to specific patterns), etc. Due to these drawbacks, it may be impractical or at least difficult to implement adversarial training in large-scale or real-time systems.

In contrast, the present disclosure utilizes a collaborative framework (as opposed to an adversarial framework) to training its machine learning models. For example, the summary generator module 210 and the summary evaluator module 250 share a common objective: the summary generator module 210 aims to produce high-quality summaries that are rewarded with high scores from the summary evaluator module 250, while the summary evaluator module 250 seeks to accurately assign high scores to well-crafted summaries by the summary generator module 210. This collaboration, rather than opposition, sets the framework apart from adversarial training. The framework of the present disclosure is also easy to implement (e.g., having lower complexity and/or computational overhead) and can be generalized to a variety of contexts. As such, the various aspects of the present disclosure are well-suited for implementation in large-scale and/or real-time systems.

Moreover, since the machine learning model can generate better summaries, it avoids the generation of low-quality summaries (in a production environment) that should not have been generated in the first place. By doing so, the present disclosure reduces the waste of electronic resources associated with the low-quality summaries that should never have been generated. In other words, the generation of low-quality summaries in a production environment would have necessarily led to the consumption of computer processing power and/or network communication bandwidth. If these low-quality summaries were not generated at all, then the consumption of the computer processing power and/or network communication bandwidth would be reduced or eliminated. Therefore, by generating high-quality summaries, the present disclosure helps to conserve computer processing power and/or network communication bandwidth, and as such improves the functionality of a computer.

The inventive ideas of the present disclosure are also integrated into a practical application, for example into the machine learning module 198 or the system 200 discussed above. Such a practical application can continuously and automatically tune the prompts for machine learning models (e.g., LLMs), which in turn leads to the continuous improvement in the ability of the machine learning models herein to generate better summaries and distinguish between high-quality and low-quality summaries. This is particularly helpful when the prompts need to be written in a natural language, since traditional techniques of tuning prompts like gradient descent cannot be used. As such, the present disclosure may transform an otherwise generic computer into a versatile machine that can be adapted to a variety of environments (e.g., including the environments where natural language prompts for machine learning models are needed), which is a practical application of the concept of performing machine learning.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: accessing a plurality of summaries generated by a summary generator module; accessing a plurality of negative samples generated by a disruptor module, wherein the plurality of negative samples are tailored to one or more specified criteria; combining the plurality of summaries and the plurality of negative samples into a dataset; evaluating the dataset via a summary evaluator module; calculating, based on the evaluating, a plurality of scores for the plurality of summaries and the plurality of negative samples; tuning, via a recursive auto prompt tuning module, at least one of the summary generator module or the summary evaluator module, wherein the tuning is automatically performed based on the calculated plurality of scores; and iterating at least the evaluating, the calculating, and the tuning for one or more cycles.

Another aspect of the present disclosure involves a system that includes a non-transitory memory and one or more hardware processors coupled to the non-transitory memory and configured to read instructions from the non-transitory memory to cause the system to perform operations comprising: generating, at least in part via a summary generator module, a plurality of first summaries, wherein the summary generator module comprises a first machine learning model; generating, at least in part via a disruptor module, a plurality of second summaries, wherein the plurality of second summaries have a reduced quality compared to the first summaries according to one or more specific metrics; evaluating, at least in part via a summary evaluator module, the quality of the plurality of the first summaries and the plurality of the second summaries, wherein the summary evaluator module comprises a second machine learning model; generating, at least in part via a prompt tuning module, one or more prompts for the first machine learning model or the second machine learning model, wherein the prompt tuning module generates the one or more prompts based on a result of the evaluating; and iterating the generating the plurality of first summaries, the generating the plurality of second summaries, the evaluating, and the generating for a plurality of iterations.

Yet another aspect of the present disclosure involves a non-transitory machine-readable medium having stored thereon machine-readable instructions executable to cause a machine to perform operations comprising: accessing a plurality of summaries generated by a first Large Language Model (LLM), based on one or more first prompts; accessing a plurality of negative samples generated by a disruptor module based on one or more specified criteria; combining the plurality of summaries and the plurality of negative samples into a dataset; evaluating, via a second LLM based on one or more second prompts, a dataset that comprises the plurality of summaries and the plurality of negative samples, wherein the evaluating produces a respective score for each summary of the plurality of summaries and for each negative sample of the plurality of negative samples; generating, based on the evaluating and via a prompt tuning module, one or more revised prompts for at least one of the first LLM or the second LLM; and using the one or more revised prompts to prompt the first LLM to generate additional summaries or to prompt the second LLM to perform additional evaluations.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing a plurality of summaries generated by a summary generator module;
accessing a plurality of negative samples generated by a disruptor module, wherein the plurality of negative samples are tailored to one or more specified criteria;
combining the plurality of summaries and the plurality of negative samples into a dataset;
evaluating the dataset via a summary evaluator module;
calculating, based on the evaluating, a plurality of scores for the plurality of summaries and the plurality of negative samples;
tuning, via a recursive auto prompt tuning module, at least one of the summary generator module or the summary evaluator module, wherein the tuning is automatically performed based on the calculated plurality of scores; and
iterating at least the evaluating, the calculating, and the tuning for one or more cycles.

2. The method of claim 1, wherein:
the plurality of summaries comprises reports of a specified type of user activity;
the plurality of summaries are generated by the summary generator module based on a plurality of inputs to the summary generator module; and
the plurality of inputs comprise: one or more risk factors, an internal research result, an external research result, or product information.

3. The method of claim 1, wherein:
the summary generator module or the summary evaluator module comprises a large language model (LLM); and
the tuning comprises tuning one or more prompts of the LLM.

4. The method of claim 3, wherein the one or more prompts of the LLM are in a natural language.

5. The method of claim 3, wherein the tuning is performed at least in part by selecting a prompt of the one or more prompts that yielded a highest score as a template prompt for a subsequent cycle of the one or more cycles.

6. The method of claim 1, wherein the plurality of negative samples are generated by simulating a non-fluency as the one or more specified criteria.

7. The method of claim 6, wherein the non-fluency is simulated at least in part by applying one or more sentence perturbations.

8. The method of claim 1, wherein the plurality of negative samples are generated by simulating an inconsistency as the one or more specified criteria.

9. The method of claim 8, wherein the inconsistency is simulated at least in part by introducing one or more mismatches between at least some of the plurality of summaries and one or more data inputs used by the summary generator module to generate the plurality of summaries.

10. The method of claim 1, wherein at least the tuning and the iterating are performed automatically without human intervention.

11. The method of claim 1, wherein the iterating stops when an average score of the plurality of summaries of a current cycle of the one or more cycles is no better than an average score of the plurality of summaries of a previous cycle of the one or more cycles.

12. A system comprising:
one or more hardware processors; and
a non-transitory computer-readable medium having stored thereon instructions that are executable by the one or more hardware processors to cause the system to perform operations comprising:
generating, at least in part via a summary generator module, a plurality of first summaries, wherein the summary generator module comprises a first machine learning model;
generating, at least in part via a disruptor module, a plurality of second summaries, wherein the plurality of second summaries have a reduced quality compared to the first summaries according to one or more specific metrics;
evaluating, at least in part via a summary evaluator module, the quality of the plurality of the first summaries and the plurality of the second summaries, wherein the summary evaluator module comprises a second machine learning model;
generating, at least in part via a prompt tuning module, one or more prompts for the first machine learning model or the second machine learning model, wherein the prompt tuning module generates the one or more prompts based on a result of the evaluating; and
iterating the generating the plurality of first summaries, the generating the plurality of second summaries, the evaluating, and the generating for a plurality of iterations.

13. The system of claim 12, wherein:
the plurality of first summaries are generated based on one or more specified risk factors; and
the plurality of second summaries are generated by reducing a consistency or a linguistic fluency as the one or more specific metrics.

14. The system of claim 12, wherein:
the first machine learning model or the second machine learning model comprises a large language model (LLM); and
the one or more prompts comprises a LLM prompt in a natural language.

15. The system of claim 12, wherein the generating the one or more prompts comprises generating a template prompt based on the result of the evaluating, wherein the template prompt is used to generate the plurality of first summaries or the plurality of second summaries in a subsequent iteration of the plurality of iterations.

16. The system of claim 12, wherein the plurality of second summaries are generated by introducing one or more sentence perturbations to the plurality of second summaries.

17. The system of claim 12, wherein the plurality of second summaries are generated by introducing one or more mismatches between at least some of the plurality of first summaries and one or more data inputs used by the summary generator module to generate the plurality of first summaries.

18. A non-transitory machine-readable medium having stored thereon machine-readable instructions executable to cause a machine to perform operations comprising:
accessing a plurality of summaries generated by a first Large Language Model (LLM), based on one or more first prompts;
accessing a plurality of negative samples generated by a disruptor module based on one or more specified criteria;
combining the plurality of summaries and the plurality of negative samples into a dataset;
evaluating, via a second LLM based on one or more second prompts, a dataset that comprises the plurality of summaries and the plurality of negative samples, wherein the evaluating produces a respective score for each summary of the plurality of summaries and for each negative sample of the plurality of negative samples;
generating, based on the evaluating and via a prompt tuning module, one or more revised prompts for at least one of the first LLM or the second LLM; and
using the one or more revised prompts to prompt the first LLM to generate additional summaries or to prompt the second LLM to perform additional evaluations.

19. The non-transitory machine-readable medium of claim 18, wherein the one or more first prompts, the one or more second prompts, or the one or more revised prompts are in a natural language.

20. The non-transitory machine-readable medium of claim 18, wherein at least a subset of the negative samples is generated by:
applying one or more sentence perturbations to a content of the negative samples; or
mismatching a content of the negative samples and one or more data inputs used by the first LLM to generate the plurality of summaries.
